(19) United States
(12) Patent Application Publication
(10) Pub. No.: US 2017/0073543 A1
(43) Pub. Date: Mar. 16, 2017

(54) COATING SYSTEM FOR FIBER CEMENT ARTICLES

(71) Applicant: James Hardie Technology Limited, Doublin 2 (IE)

(72) Inventors: John Andrew Joecken, Palm Springs, CA (US); Luisa Gonzalez, Fontana, CA (US); Caidian Luo, Rancho Cucamonga, CA (US)

(21) Appl. No.: 15/264,371

(22) Filed: Sep. 13, 2016

Related U.S. Application Data
(60) Provisional application No. 62/218,484, filed on Sep. 14, 2015.

(51) Int. Cl. C09D 163/00; B05D 7/00; B05D 5/06; C09D 125/14

(52) U.S. Cl. CPC C09D 163/00; C09D 125/14; B05D 7/586; B05D 5/06

(57) ABSTRACT

A coating system which provides a stain finish on a fiber cement building article. The coating system comprising a sealing agent, a basecoat and a topcoat, wherein the coating system is disposed on at least one surface of the fiber cement building article whereby the sealing agent is disposed adjacent to the at least one surface of the fiber cement building article, the basecoat is disposed on the sealing agent remote from the surface of the fiber cement building article and the topcoat is disposed on the basecoat remote from the fiber cement building article.

### CROSS REFERENCE TO RELATED APPLICATIONS

This application claims the benefit of priority under 35 U.S.C. §119(e) of U.S. Provisional Application No. 62/218,484 filed on Sep. 14, 2015, which is incorporated herein by reference in its entirety.

### BACKGROUND OF THE INVENTION

Field of the Invention

The present invention generally relates to coatings for cementitious articles and methods for preparing the same, and more particularly relates to a coating system for fiber cement composite articles which provides a stain finish on the fiber cement composite article.

Description of the Related Art

Fiber cement articles are conventionally used as cladding materials to form the exterior and/or interior walls of a building by attaching the fiber cement article to a structural building frame. It is often desirable for such fiber cement articles to have a wood grain appearance. Generally a series of peaks, valleys and flattened areas are formed in low relief on the surface of the fiber cement article so as to create a wood grain pattern on the surface. The fiber cement article is then painted or stained before or after installation on the structural building frame.

Traditional stain products used on fiber cement articles include semi-transparent stains or latex solid colour stains. However such systems have limited ability to create the appearance of wood and also provide a durable stain effect.

Semi-transparent stain systems do not form an even film on the surface of the fiber cement article, instead, such systems penetrate into the porous fiber cement substrate. Often in such systems there is differential stain penetration into the fiber cement substrate. Differential penetration rates often result in the wood grain pattern being diminished. Generally, this can be attributed to the thickness of the emulsion layer sitting on the surface of the fiber cement article. If the emulsion is sufficiently thick on the surface of the fiber cement article, it will fill the valley of the wood grain pattern providing an undesirable flat appearance. Conversely, if the thickness of the emulsion layer is insufficient, the peaks of the wood grain pattern will not be coated. Consequently, the colour of the fiber cement substrate will be exposed. This does not represent a realistic stained look on the wood grain pattern. It is also known that such systems have a high Volatile Organic Compound (VOC) content and limited service life due to erosion, peeling and colour fade.

Latex solid colour stain systems are a film forming technology that generally have low to no VOC content. However such systems do not significantly embellish the wood grain pattern typically generating a monotone painted appearance on the fiber cement substrate. Latex solid colour stain systems are also subject to problems such as colour fade, adhesion loss, peeling and restoration difficulties.

In view of the foregoing, there is a need for an improved stain finish coating for fiber cement articles.

### SUMMARY OF THE INVENTION

Accordingly, the present disclosure provides in one embodiment a coating system suitable for use on a fiber cement composite article, the coating system comprising a sealing agent, a basecoat and a topcoat, wherein the coating system is disposed on at least one surface of the fiber cement composite article whereby the sealing agent is disposed adjacent to the at least one surface of the fiber cement composite article, the basecoat is disposed on the sealing agent remote from the surface of the fiber cement composite article and the topcoat is disposed on the basecoat remote from the fiber cement composite article.

In a further embodiment the sealing agent is disposed adjacent to the at least one surface of the fiber cement composite article such that the Dry Film Thickness (DFT) of the sealing agent is between 0.05 and 2 mils (1.27 μm and 50.8 μm), more preferably between 0.1 and 1.5 mils (2.54 μm and 38.1 μm) and even more preferably between 0.3 and 1.0 mils (7.62 μm and 25.4 μm); the basecoat is disposed on sealing agent such that the DFT of the basecoat is between 0.5 and 5 mils (12.7 μm and 127 μm), more preferably between 1.0 and 3 mils (25.4 μm and 76.2 μm) and even more preferably between 1.3 and 2.5 mils (33.02 μm and 63.5 μm); and the topcoat is disposed on the basecoat such that the DFT of the topcoat is between 0.05 and 2 mils (1.27 μm and 50.8 μm), more preferably between 0.1 and 1.5 mils (2.54 μm and 38.1 μm) and even more preferably between 0.3 and 1.0 mils (7.62 μm and 25.4 μm).

It is to be understood that in one embodiment, a coating system provided herein can be disposed on all or a portion of the at least one surface of the fiber cement composite article. It is also to be understood that in a further embodiment, a coating system provided herein can be disposed on one or more surfaces of the fiber cement composite article.

For convenience throughout the following description, reference will be made to layers of a coating system provided herein. It will be understood that in the context of the following description the term layer used in conjunction with the terms sealing agent, basecoat, and topcoat is used to describe a thickness of each respective material. It is not intended to limit a coating system provided herein to a single as-applied coat of each respective material. In some instances it may be necessary or desirable to apply one or more coats of each respective material. Accordingly the terms sealing layer, basecoat layer and topcoat layer should not be seen as limiting.

Coating systems according to embodiments provided herein enhance a relief pattern on a surface of a fiber cement substrate. Unlike a typical stain, a coating system provided herein will not fill the valleys of a wood relief fiber cement substrate. Rather, a coating system of the present disclosure can provide a film of selected thickenss and hue on both peaks and valleys of a wood relief fiber cement substrate. Thus, the grained appearance of stained wood can be exhibited and accentuated in a coated fiber cement article. Accordingly, an advantage of coating systems provided herein is that each of the sealing agent, basecoat and topcoat are applied to the fiber cement composite article such that a visible difference is created between the peaks, valleys and flattened areas of the wood grain pattern on the surface of the fiber cement composite article, thereby enhancing the overall aesthetic appeal of the coated fiber cement composite article.

It is acknowledged that the terms “comprise(s),” “comprised of” and “comprising” may, under varying jurisdictions be provided with either an exclusive or inclusive meaning. For the purpose of this specification, the terms “comprise(s),” “comprised of” and “comprising” shall have inclusive meanings, and should be taken to mean an inclusion of not only the listed components directly or explicitly referenced, but also other non-specified components. Accordingly, the terms “comprise(s),” “comprised of” and “comprising” are to be attributed with as broad an interpretation as possible within any given jurisdiction.

In one embodiment, the sealing agent can comprise at least one resin that is suitable for use in a sealing agent. In a further embodiment, the at least one resin can comprise resin solids. In a still further embodiment, the sealing agent can comprise resin solids between 2.0%±0.5% and 99.5%±0.5% of the sealing agent by weight, and more preferably between 15.0%±0.5% and 28%±0.5% of the sealing agent by weight.

In a further embodiment, the at least one resin can be selected from aromatic isocyanates, aliphatic isocyanates, blocked isocyanates, an epoxy, silicones, siloxanes, silanes, polyurethanes, acrylates, acrylics, polyester, fluoropolymers, fluorinated acrylics, and styrene acrylics or combinations of the same. Optionally the at least one resin can comprise a water based resin or a solvent based resin. In a further embodiment of the disclosure, the at least one resin can be a UV curable or moisture curable resin. In one embodiment, the sealing agent can comprise an epoxy silane resin.

Advantageously, the sealing agent provides a moisture barrier on the fiber cement composite article whilst also providing a uniform surface upon which the basecoat layer of the coating system can be applied. Conveniently, the sealing agent also serves to provide enhanced adhesion of the basecoat layer on the fiber cement composite article relative to a system in which the basecoat layer is applied directly to the fiber cement composite article, or to a system in which a traditional stain is applied.

Optionally, in a further embodiment the sealing agent can further comprise at least one pigment.

In a further embodiment, each of the topcoat and basecoat can comprise at least one pigment, at least one binder, at least one liquid and at least one additive.

In an embodiment, a pigment of the sealing agent, the basecoat and the topcoat can comprise one or more pigments selected from one or more of inorganic pigments, organic pigments and combinations thereof, wherein the inorganic pigment can be selected from Han Purples, Ultramarines, Cobalt Violets, Cobalt Blues, Cerulean Blues, Egyptian Blues, Han Blues, Prussian Blues, Azurites, Malachites, Cadmium Greens, Viridians, Verdigris, Chrome Greens, Paris Greens, Scheele's Greens, Orpiments, Cadmium Yellows, Chrome Yellows, Cobalt Yellows, Yellow Ochres, Naples Yellows, Titanium Yellows, Titanium Beiges, Cadmium Oranges, Chrome Oranges, Cadmium Reds, Venetian Reds, Red Ochres, Burnt Siennas, Vermilions, Red Leads, Burnt Ochres, Raw Umbers, Burnt Umbers, Raw Siennas, Carbon Blacks, Ivory Blacks, Vine Blacks, Lamp Blacks, Iron Blacks, Titanium Blacks, Antimony Whites, Barium Sulfates, White Leads, Titanium Whites, Zinc Whites and combinations thereof, and the organic pigment can be selected from Fast Yellows, Permanent Yellows, Brilliant Yellows, Fast Oranges, Permanent Oranges, Toluidene Reds, Permanent Reds, Scarlet Reds, Fast brilliant Reds, Fast Rose Reds, Fast Reds, Red Lakes, Carmine Reds, Lithol Rubbines, Fast Bordeaux, Fast Pinks, Fast Violets, Cyanine Blues, Cyanine Greens, and combinations thereof.

In a yet further embodiment, each of the basecoat and topcoat can optionally further comprise extender pigments, wherein the extender pigments are added to either or both of the basecoat and topcoat. In a further embodiment, the extender pigments can comprise inorganic pigments selected from one or more of titanium dioxide, calcium carbonate, calcium sulphate, diatomaceous silica and china clays.

In an additional further embodiment, it is preferable for the basecoat and the topcoat to comprise different formulations whereby the colour appearance parameters of the basecoat are different from the colour appearance parameters of the topcoat. It is preferable for there to be a visible colour difference between the topcoat and the basecoat. In one embodiment the primary colour difference is attributable to the topcoat having less pigment than the basecoat which causes a contrast between lightness and darkness, wherein the topcoat is darker than the basecoat. In a further embodiment, the difference between the lightness value (DL) of the topcoat and the basecoat is between approximately −25 to −35; the difference between the red/green value (Da) of the topcoat and the basecoat is approximately 0.01 to 1; the difference between the yellow/blue value (Db) of the topcoat and the basecoat is approximately −1 to −6; and the difference between the total colour value (DE) of the topcoat and the basecoat is approximately 25 to 35. For example, in one embodiment, the basecoat has a lighter colour (e.g. yellow) than the topcoat, which has a darker colour (e.g. brown). The effect of this colour differentiation is that it enhances the wood grain pattern on the fibre cement composite article. This effect is further enhanced during use, in particular should the topcoat become damaged. In such an instance, the appearance of the lighter colour basecoat in the wood grain pattern is reflective of natural weathering of wood.

In a further embodiment, the at least one pigment can comprise between 2%±0.5% and 79%±0.5% by weight of each of the sealing agent, the basecoat and the topcoat respectively. In one embodiment the at least one pigment of the basecoat comprises between 40%±0.5% and 60%±0.5% by weight of the basecoat, and more preferably between 42%±0.5% and 53%±0.5% by weight of the basecoat. In one embodiment the at least one pigment of the topcoat comprises between 10%±0.5% and 35%±0.5% by weight of the topcoat, and more preferably between 20%±0.5% and 30%±0.5% by weight of the topcoat. In a further embodiment the at least one pigment is less than 10%±0.5% by weight of the sealing agent.

In a further embodiment, each of the of the sealing agent, the basecoat and the topcoat can comprise a Pigment Volume Concentration (PVC) between 2%±0.5% and 70%±0.5%. In a further embodiment, the Pigment Volume Concentration (PVC) of the topcoat can be between 5%±0.5% and 25%±0.5%, or between 10%±0.5% and 30%±0.5%. In a further embodiment, the Pigment Volume Concentration (PVC) of the basecoat can be between 35%±0.5% and 65%±0.5%. In a further embodiment, the Pigment Volume Concentration (PVC) of the sealer can be <10%±0.5% and more preferably <5%±0.5%. Generally, it is to be understood that the weight addition of the at least one pigment in the sealing agent, the basecoat and the topcoat respectively results in a PVC that does not exceed the critical PVC for each of the sealing agent, the basecoat and the topcoat respectively.

In a further embodiment, each of the sealing agent, the basecoat and the topcoat can further comprise at least one UV absorber (“UVA”) and at least one Hindered Amine Light Stabiliser (HALS) in the formulation. In a further embodiment, each of the sealing agent, the basecoat and the topcoat can further comprise either of the at least one UV absorber or the at least one Hindered Amine Light Stabiliser (HALS) in the formulation.

The at least one UV absorber functions to absorb UV rays from the sunlight and dissipate them through the surface of the coating. In one embodiment, a UV absorber comprises 2-hydroxyphenyl-benzophenones, 2-(2-hydroxyphenyl)benzotriazole or 2-hydroxyphenyl-s-triazine, or a derivative thereof, however it is understood that any suitable UV absorber known to a person skilled in the art can also be used.

In a further embodiment, each of the sealer, basecoat, and topcoat can comprise between 0.3%±0.3% and 4%±0.5% and more preferably between 0.3%±0.3% and 2%±0.5% by weight of the at least one UV absorber.

The at least one HALS functions to neutralize photochemically produced free-radicals in the coating resin. In one embodiment, the at least one HALS can comprise di or oligo-functional HALS based on tetramethylpiperidine derivatives, however, it is understood that any suitable HALS known to a person skilled in the art can also be used.

In a further embodiment, each of the sealer, basecoat, and topcoat can comprise between 0.6%±0.5% and 8%±0.5% and more preferably between 0.6%±0.5% and 4%±0.5% by weight of the at least one HALS.

An advantage of adding the at least one UV absorber and/or the at least one HALS is that each enhances the performance of a coating system of the present disclosure over time. In particular the at least one UV absorber and/or the at least one HALS prevent fade and enhance colour retention whilst improving chalk resistance. Surprisingly, it has been discovered that the performance of a coating system is synergistically enhanced when a UVA and/or HALS is included in each of the sealing agent layer, the basecoat layer, and the topcoat layer.

In a further embodiment, a binder included in a sealer, basecoat, and/or topcoat can be selected from acrylic polymers, alkyd polymers or epoxy polymers as known to the person skilled in the art. In one embodiment a binder can comprise an acrylic resin, wherein the acrylic resin can be selected from acrylic latex, vinyl acrylic latex and styrene-acrylic latex resins.

In a further embodiment, each of the sealer, basecoat, and topcoat can comprise between 14%±0.5% and 50%±0.5% and more preferably between 14%±0.5% and 30%±0.5% by weight of a binder.

In a further embodiment, a liquid can comprise a suspending agent, solvent and/or co-solvent, wherein the liquid can comprise one or more of water, aliphatic hydrocarbons, aromatic hydrocarbons, cholorinated hydrocarbons, terpenes, alcohols, esters including butyl esters, ethers including butyl ether, ketones or glycol ethers including propylene glycols. In a further embodiment, a liquid can further comprise a co-solvent selected from aliphatic hydrocarbons, aromatic hydrocarbons, cholorinated hydrocarbons, terpenes, alcohols, esters including butyl esters, ethers including butyl ether, ketones or glycol ethers including propylene glycols such that either or both of the basecoat and topcoat are fast cured.

In a further embodiment, each of the sealer, basecoat, and topcoat can comprise between 35%±0.5% and 55%±0.5% by weight of the liquid.

In a further embodiment, the basecoat and/or the topcoat can further comprise one or more additives in the formulation.

In a further embodiment, the one or more additives can be selected from fillers, surfactants, dispersants, defoamers, catalysts, coalescing agents, amines, preservatives, biocides, mildewcides, fungicides, glycols, colorants, dyes, rheology modifiers, heat stabilisers, leveling agents, anti-cratering agents, curing indicators, plasticisers, sedimentation inhibitors, photoinitiators, optical brighteners, anti-corrosion agents, and combinations thereof. In a further embodiment, at least one of the basecoat and the topcoat can comprise additives at a combined total additive percentage of from about 0% to 20% by weight of the basecoat or topcoat respectively.

In a further embodiment, the sealer, basecoat, and/or the topcoat can comprise at least one filler. In one embodiment, the at least one filler can be selected from natural minerals, synthetic minerals, and combinations thereof, wherein the group of natural minerals comprises oxides, silicates, hydrated silicates, titanates, carbonates, sulfates and hydroxides and the group of synthetic minerals comprises oxides of silicon, aluminium, magnesium, titanium, iron, zinc, yttrium and zirconium. In a further embodiment a filler can comprise an extender wherein the extender can comprise secondary pigments commonly used in primer and house paints, such as, for example, titanium dioxide, inorganic color pigments, and organic color pigments. In addition the extender can further comprise other materials commonly used in primer and house paints, including, for example, clays, talc, calcium silicate, and silica.

In a further embodiment, each of the sealer, basecoat, and topcoat can comprise between 0.5%±0.5% and 80%±0.5% by weight of the filler.

In a further embodiment, an additive can comprise a dispersant used to separate and stabilize the pigment particles of the basecoat and/or topcoat respectively. The dispersant comprises dispersants commonly used in primer and house paints including, for example, anionic dispersants, non-ionic dispersants and zwitter ionic dispersants.

In a further embodiment, an additive can comprise a rheology modifier. Addition of selected rheology modifier(s) can be used to control how the basecoat and/or topcoat respectively flow when applied to a substrate. A rheology modifier can be selected from those known to persons of skill in the art as being used in primer and house paints including, for example, HEUR hydroxyl modified urethane, HASE alkali swellable, cellulosic and clay thickeners, and combinations thereof.

In some embodiments, each of the sealer, basecoat, and topcoat can comprise between 0% and 20%±0.5% by weight of combined total additives.

In a further embodiment, there is provided a coated fiber cement composite article wherein the fiber cement composite article is coated with a coating system, the fibre cement composite article comprising a fiber cement substrate having a wood grain pattern on at least one surface; and the coating system comprising at least one sealing agent; a basecoat and a topcoat, wherein the sealing agent is applied to at least a portion of the surface of the fiber cement composite article having a wood grain relief pattern and at least partially cured, the basecoat is applied to the at least partially cured sealing agent and at least partially cured; and wherein the topcoat is applied to the at least partially cured basecoat layer and at least partially cured such that the at least one sealing agent, basecoat and topcoat operate synergistically to enhance the wood grain pattern on the fiber cement substrate by creating a visible difference between the peaks, valleys and flattened areas of the wood grain relief pattern.

In some embodiments, each of the sealing agent and the basecoat layers are fully cured before the basecoat and topcoat layers respectively are applied.

One of the advantages of the coating systems of the present disclosure is that the use of a coating system provided herein creates a sealed uniform surface on the fiber cement composite article which forms a moisture barrier whilst enhancing any pattern, such as, for instance, wood grain relief, on the fiber cement composite article. In an exemplary embodiment, the fiber cement composite article can comprise a fiber cement composite article which has a wood grain effect on a surface, for example the upper surface, wherein use of a coating agent provided herein enhances the pattern on the fiber cement composite article such that the fiber cement composite article appears more like wood.

In one embodiment, a fiber cement composite article can be included in an exterior or interior fiber cement composite building article. In a further embodiment, a siding panel, plank, shingle, trim or decking can comprise a coated fiber cement composite article provided herein.

In a further embodiment, the Dry Film Thickness (DFT) of the sealing agent can be between between 0.05 and 2 mils (1.27 μm and 50.8 μm), more preferably between 0.1 and 1.5 mils (2.54 μm and 38.1 μm) and even more preferably between 0.3 and 1.0 mils (7.62 μm and 25.4 μm). In a further embodiment, the DFT of the basecoat can be between 0.5 and 5 mils (12.7 μm and 127 μm), more preferably between 1.0 and 3 mils (25.4 μm and 76.2 μm) and even more preferably between 1.3 and 2.5 mils (33.02 μm and 63.5 μm). In a further embodiment the DFT of the topcoat can be between 0.05 and 2 mils (1.27 μm and 50.8 μm), more preferably between 0.1 and 1.5 mils (2.54 μm and 38.1 μm) and even more preferably between 0.3 and 1.0 mils (7.62 μm and 25.4 μm).

It is to be understood that the Dry Film Thickness of each layer is not limited to their respective values and can be altered as required by a person skilled in the art to obtain the desired physical properties of the coated fiber cement building article.

In a further embodiment of the disclosure, there is provided a method of manufacturing a coated fibre cement composite article, wherein the method can comprise the steps of:
(a) providing a fibre cement composite substrate having a wood grain pattern on at least one surface;
(b) applying at least one layer of a sealing agent to at least a portion of the fibre cement composite substrate on the surface having a wood grain pattern;
(c) at least partially curing each coating layer prior to applying any further coating layers;
(d) applying at least one layer of a basecoat to the at least partially cured sealing agent;
(e) at least partially curing the basecoat prior to applying any further coating layers;
(f) applying at least one layer of a topcoat to the at least partially cured basecoat; and
(g) at least partially curing the topcoat.

Optionally, in a further embodiment of the method, each of steps (b), (d) and (f) can further comprise applying at least one or more further layers of a sealing agent, a basecoat and a topcoat respectively.

In a further embodiment of the method, step (b) can further comprise applying at least one or more layers of a sealing agent until the Dry Film Thickness (DFT) of the sealing agent is between between 0.05 and 2 mils (1.27 μm and 50.8 μm), more preferably between 0.1 and 1.5 mils (2.54 μm and 38.1 μm) and even more preferably between 0.3 and 1.0 mils (7.62 μm and 25.4 μm).

In a further embodiment of the method, step (d) can further comprise applying at least one or more layers of a basecoat until the Dry Film Thickness (DFT) of the basecoat is between 0.5 and 5 mils (12.7 μm and 127 μm), more preferably between 1.0 and 3 mils (25.4 μm and 76.2 μm) and even more preferably between 1.3 and 2.5 mils (33.02 μm and 63.5 μm).

In a further embodiment of the method, step (f) can further comprise applying at least one or more layers of a topcoat until the Dry Film Thickness (DFT) of the topcoat is between 0.05 and 2 mils (1.27 μm and 50.8 μm), more preferably between 0.1 and 1.5 mils (2.54 μm and 38.1 μm) and even more preferably between 0.3 and 1.0 mils (7.62 μm and 25.4 μm).

In a further embodiment of the method, the method of applying each of the sealing agent, the basecoat and the topcoat can comprise one or more of the following application methods: brush coating, roller coating, direct roll coating, dipping, flowcoating, spraying, hot spraying, electrostatic spraying or vacuum coating.

In a further embodiment, the method of partially curing each of the sealing agent, the basecoat and the topcoat can comprise exposing the coated fiber cement composite substrate to at least one of heat, moisture, UV radiation, NIR radiation, IR radiation, RF radiation, gamma ray radiation and electron beam radiation.

In a further embodiment, the sealing agent can be at least partially cured on the fiber cement composite product for a period of between 30 seconds and 5 minutes at a temperature range between approximately 130° F. (54.5° C.) and approximately 180° F. (76.7° C.).

In a further embodiment, the basecoat can be at least partially cured on the fiber cement composite product for a period of between 30 seconds and 5 minutes at a temperature range between approximately 160° F. (71.1° C.) and approximately 200° F. (93.3° C.).

In a further embodiment, the topcoat can be at least partially cured on the fiber cement composite product for a period of between 30 seconds and 5 minutes at a temperature range between approximately 160° F. (71.1° C.) and approximately 200° F. (93.3° C.).

Various embodiments of coating systems provided herein for fiber cement composite articles will be described in greater detail below.

### BRIEF DESCRIPTION OF THE DRAWINGS

FIG. 1 is a top view of a section of a fiber cement composite article coated with a coating system provided herein.

FIG. 2 is a side sectional view of the fiber cement composite article of FIG. 1 showing a coating system provided herein.

FIG. 3 is a graph showing the QUVB weathering dL values of fiber cement composite article samples coated with various embodiments of a coating system provided herein after 4000 hrs of exposure.

FIG. 4 is a graph showing the QUVB weathering dL values of fiber cement composite article samples coated with various embodiments of a coating system provided herein after 4000 hrs of exposure.

FIG. 5 is a graph showing QUVA weathering dL values of fiber cement composite articles coated with various embodiments of coating systems provided herein.

### DETAILED DESCRIPTION OF THE PREFERRED EMBODIMENT

In the following detailed description, reference is made to the accompanying drawings, which form a part hereof. In the drawings, similar symbols typically identify similar components, unless context dictates otherwise. The illustrative embodiments described in the detailed description and drawings are not meant to be limiting. Other embodiments may be used, and other changes may be made, without departing from the spirit or scope of the subject matter presented here. It will be readily understood that the embodiments of the present disclosure, as generally described herein, and illustrated in the figures, can be arranged, substituted, combined, and designed in a wide variety of different configurations, all of which are explicitly contemplated and made part of this disclosure.

As used herein, the terms “sealing agent” or “sealer” may refer to a composition, and are not limited to a single component. The terms “sealing agent” and “sealer” are used interchangeably herein.

FIG. 1 shows a section of a coated fiber cement composite article 1 comprising a fiber cement substrate 16 and at least one exterior surface. A wood grain pattern is formed in low relief on at least one exterior surface of the fiber cement substrate 16. A coating system 2 is applied to the exterior surface of the fiber cement substrate 16 on which the wood grain pattern was formed. As described in greater detail below, the coating system 2 is formulated and applied to the fiber cement substrate 16 in a manner such that the coating system accentuates the wood grain pattern or other textured relief on the exterior surface of the fiber cement substrate 16.

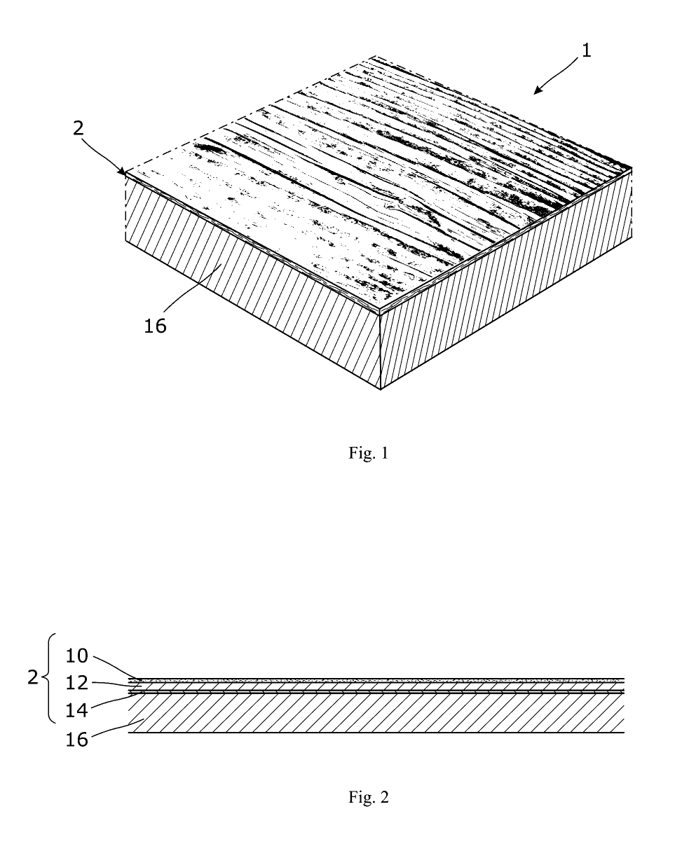

FIG. 2 is a side sectional view of the coated fiber cement composite article 1 of FIG. 1. The coating system 2 comprises a sealing agent 14, a basecoat 12 and a topcoat 10. Sealing agent 14 is applied to the surface of the fiber cement composite article 1 which has the wood grain pattern formed in low relief thereupon. Sealing agent 14 is then at least partially cured prior to any further layers being applied to it. In practice it is preferable for the sealing agent 14 to be fully cured before application of further layers however once the sealing agent has cured sufficiently to form a seal on the surface of the fiber cement composite article 1 it is possible to apply further layers on top of the sealing agent 14. In the embodiment shown, the sealing agent was partially cured on the fiber cement composite product for a period of between 30 seconds and 5 minutes at a temperature range between approximately 130° F. (54.5° C.) and approximately 180° F. (76.7° C.).

The sealing agent can be selected based on the depth of the wood grain relief and light reflective properties of the basecoat and topcoat. In one embodiment, the Dry Film Thickness (DFT) of the sealing agent 14 can be between between 0.05 and 2 mils (1.27 μm and 50.8 μm), more preferably between 0.1 and 1.5 mils (2.54 μm and 38.1 μm) and even more preferably between 0.3 and 1.0 mils (7.62 μm and 25.4 μm).

Basecoat 12 is then applied to the at least partially cured sealing agent 14 and is then at least partially cured. Similarly to the sealing agent 14, it is preferable for the basecoat 12 to be fully cured before application of further layers, however, once the basecoat 12 has cured sufficiently to form a film on the surface of the sealing agent 14, it is possible to apply further layers on top of the basecoat 12. Basecoat 12 is cured on the fiber cement composite substrate for a period of between 30 seconds and 5 minutes at a temperature range between approximately 160° F. (71.1° C.) and approximately 200° F. (93.3° C.). The DFT of basecoat 12 is between 0.5 and 5 mils (12.7 μm and 127 μm), more preferably between 1.0 and 3 mils (25.4 μm and 76.2 μm) and even more preferably between 1.3 and 2.5 mils (33.02 μm and 63.5 μm). If necessary, further layers, or coats, of the basecoat layer may be applied by the person skilled in the art to achieve a dry film thickness desired to achieve the effect of the coating system.

Finally, topcoat 10 is applied to an upper surface of the basecoat 12. The DFT of topcoat 10 is between 0.05 and 2 mils (1.27 μm and 50.8 μm), more preferably between 0.1 and 1.5 mils (2.54 μm and 38.1 μm) and even more preferably between 0.3 and 1.0 mils (7.62 μm and 25.4 μm). The topcoat 10 is then cured. In some embodiments, topcoat 10 is fully cured on the fiber cement composite article 16. In other embodiments, topcoat 10 is partially cured during manufacture and then allowed to fully cure naturally over time. In this particular embodiment, topcoat 10 is cured on the fiber cement composite product for a period of between 30 seconds and 5 minutes at a temperature range between approximately 160° F. (71.1° C.) and approximately 200° F. (93.3° C.).

In some embodiments, fiber cement substrate 16 can include at least one surface having a textured relief, such as in the pattern of a wood grain. Generally, a textured relief on a fiber cement substrate can be chosen to correspond to that of a desired wood grain. The textured relief can be characterized by its depth, width, average degree of curvature, characteristic shape, and/or extent of irregularities. Generally, depth is measured as an average distance from the bottom of a valley to the top of an adjacent peak. In an embodiment, a textured relief can have an average depth of 5 to 50 mils (127 μm to 1.3 mm), 10 to 40 mils (254 μm to 1 mm), or 15 to 35 mils (381 μm to 889 μm). In preferred embodiments, a wood grain relief can have an average depth of 20 to 30 mils (508 μm to 762 μm), or about 25 mils (635 μm).

Additionally, the wood grain relief can advantageously be correlated with the DFT of the sealer layer. In certain embodiments, the DFT of the sealing agent can be selected to provide a wood-look surface on a textured substrate. Generally, this advantage is realized when the texture of the substrate is reflected in the surface texture of the coating system. In certain embodiments, the ratio of sealer layer DFT to wood grain relief depth can be about 0.1:1 to about 10:1, about 0.5:1 to about 5:1, about 1:1 to about 5:1, or about 1:1 to about 3:1. In further embodiments, the ratio of sealer layer DFT to wood grain relief depth can be about 2:1.

Basecoat 12 and topcoat 10, along with sealing agent 14, enhance the wood grain pattern on the fiber cement substrate 16. In some embodiments, the DFT of each coating layer is selected to provide a wood grain appearance. As described above, a sealing agent can be provided in a layer of appropriate DFT to maintain a texture or relief of the underlying substrate surface. A basecoat and topcoat as provided herein act together with each other, and with the sealer, to provide a coating surface with the appearance of wood. Thus, in some embodiments, the DFT of the basecoat and topcoat can be selected according to the sealer layer DFT and wood grain relief to enhance wood grain texture and provide the appearance of wood. In some embodiments, a sealing agent layer, basecoat layer, and topcoat layer in a coating system provided herein can have defined DFTs relative to each other. In some embodiments, the ratio of sealer layer DFT:basecoat layer DFT:topcoat layer DFT can be 1:10:1 to 1:2:2, or preferably 1:10:1 to 1:2.5:1.5, or more preferably 1:4.3:1 to 1:2.5:1.2.

A coating system provided herein preferably can include one layer of each of a sealer, a basecoat, and a topcoat, but each of the sealer layer, basecoat layer, and topcoat layer can be applied in one or a plurality of coats of sealer, basecoat, and topcoat, respectively.

Thus, coating systems including sealing agent 14, basecoat 12 and topcoat 10 operate synergistically to enhance the wood grain pattern on the fiber cement substrate 16 by creating a visible difference between the peaks, valleys and flattened areas of the wood grain pattern. Coating systems provided herein additionally create a multicolor palette to highlight a wood grain texture or pattern in a manner that creates the appearance of wood, and provide superior durability to weathering.

It is preferable for there to be a visible colour difference between the topcoat and the basecoat. Generally, the basecoat layer and topcoat layer together provide a contrast between lighter and darker. Generally, a coating system provided herein will include a topcoat darker than the basecoat. For example, a basecoat generally has a lighter colour (e.g. yellow) than a topcoat, (e.g. red, red-brown or brown). The effect of this colour differentiation is that it enhances the wood grain pattern on the fiber cement composite article. This is because the topcoat layer of a composition and thickness provided herein should not completely obscure the underlying basecoat layer. Thus, some basecoat layer can be visible despite the topcoat. The visibility of the basecoat layer provides an uneven appearance which, due in part to the texture provided by the substrate relief, has the appearance of wood. This effect is further enhanced during use, in particular should the topcoat become damaged. In such an instance, the appearance of the lighter colour basecoat, as revealed by the wearing of the topcoat, is reflective of natural weathering of wood. In some embodiments, a coating system of the present disclosure will maintain the appearance of wood after 1000, 3000, 5000, 7000, 8000, or 9000 hours of exposure to UV rays. In some embodiments, change in dL of a coating system provided herein after 9000 hours of exposure to UV is less than about 1, less than about 2, less than about 3, less than about 4, less than about 5, less than about 7, or less than about 10.

The difference in optical characteristics of the basecoat and topcoat should be chosen to provide a wood look upon application of a coating system provided herein to a fiber cement substrate. It has been discovered that certain color relationships between the sealing agent, basecoat, and topcoat, correlate to a wood look. In particular, lightness value, red/green value, and yellow/blue value can advantageously be compared between the basecoat and topcoat. In an embodiment, the difference in lightness value (DL) of the topcoat to the basecoat is between approximately −25 to −35; the difference between the red/green value (Da) of the topcoat and the basecoat is approximately 0.01 to 1; the difference between the yellow/blue value (Db) of the topcoat and the basecoat is approximately −1 to −6; and the difference between the total colour value (DE) of the topcoat and the basecoat is approximately 25 to 35. In a further embodiment, the DL of topcoat to basecoat is negative.

Sealing agent 14 advantageously creates a seal or film on the fiber cement substrate. Film formation provides an even thickness coating over an uneven surface (e.g., due to the wood-look relief of the fiber cement substrate surface) of the fiber cement. Thus, the film does not fill in the valleys formed by a textured surface and retains the texture of the substrate. The thickness of a sealer layer is also important. A sealer provided herein of a thickness as provided herein will provide a film over the substrate surface while retaining a texture, for example a wood look relief, of the substrate, and while providing a suitable surface for application of a basecoat and a topcoat. A sealing agent should be tinted to mask the color of the underlying fiber cement substrate. A sealing agent should be chosen with a low particulate content. In some embodiments, a sealing agent will have a PVC of less than 10%.

In some embodiments described herein sealing agent 14 can comprise an epoxy silane resin. In some embodiments, a tinted sealing agent can comprise one or more pigments. In some embodiments, a sealing agent can comprise both an epoxy silane resin and one or more pigments.

In a further embodiment, the sealing agent can be selected for film formation. In a still further embodiment, the sealing agent can be selected to undergo crosslinking. In a yet further embodiment, the sealing agent can be selected to undergo crosslinking in a curing step. In still further embodiments, a sealing agent can include both hydrophobic and hydrophilic functionalities. In some embodiments, a sealing agent can be selected that bonds to active sites on the substrate surface.

In some embodiments, a UV absorber and/or a Hindered Amine Light Stabiliser (HALS) can be added to a sealer. Table One below provides an exemplary formulation of sealing agents with and without a pigment or tint used in a coating system provided herein.

An advantage of adding a UV absorber and/or a HALS to a sealer, basecoat, and/or topcoat is that each enhances the performance of a coating system over time. In other words, a coating system provided herein will weather more favourably, in terms of both appearance and durability, compared to a coating formulation lacking a UV absorber and/or HALS. Adding a UV absorber and/or a HALS to each of the sealing agent, basecoat, and topcoat unexpectedly provides an advantage over adding a UV absorber and/or a HALS to only one or two layers of the coating system. In some embodiments, a sealer, basecoat, and/or topcoat can include about 0.01 to 2% by weight of a UVA and/or a HALS. In further embodiments, a sealer, basecoat, and/or topcoat can include about 0.1 to 1% by weight of a UVA and/or a HALS. In still further embodiments, a sealer, basecoat, and/or topcoat can include about 0.2 to 0.8% by weight of a UVA and/or a HALS. In further embodments, each of the sealer, basecoat, and topcoat can comprise about 0.3%±0.3% to 4%±0.5% and preferably about 0.3%±0.3% to 2%±0.5% by weight of the at least one UVA. In further embodments, each of the sealer, basecoat, and topcoat can comprise about 0.6%±0.5% to 8%±0.5% and preferably about 0.6%±0.5% to 4%±0.5% by weight of the at least one HALS. In certain embodiments, each of a sealer, a basecoat, and a topcoat can include a UVA and/or a HALS. In yet further embodiments, at least one of the sealer, basecoat, and topcoat can include both a UVA and a HALS. In still further embodiments, the sealer, basecoat, and topcoat can include both a UVA and a HALS.

In some embodiments, a coating system provided herein does not include oil based stain. In further embodiments, a coating system provided herein does not include alkyd based stain.

### Examples

TABLE ONE
Example formulations for sealing agents of a coating system provided
herein.

| | SEALING AGENT | SEALING AGENT |
|---|---|---|
| | without Tint | with Tint |
| Epoxy Resin PART A | 31.54 g | 31.54 g |
| Epoxy Resin PART B | 20 g | 20 g |
| Pigments | — | 1.62 g |
| Water | 22.7 g | 22.7 g |
| UV Absorber | 0.12 g | 0.12 g |
| HALS | 0.06 g | 0.06 g |

Sealing agents were formulated according to TABLE ONE.

Basecoat 12 and topcoat 10 each comprise a satin finish paint based on a styrene acrylic binder. Again, in some embodiments, a UV absorber and a Hindered Amine Light Stabiliser (HALS) were added to both the basecoat 12 and topcoat 10. In an exemplary embodiment approximately 0.14 g of UV absorber (CIBA® TINUVIN® 1130) and approximately 0.28 g of Hindered Amine Light Stabiliser (CIBA® TINUVIN® 292) were added to approximately 50 g of an acrylic latex basecoat and an acrylic latex topcoat paint respectively.

In the following examples, a number of samples of fiber cement composite articles were coated with one embodiment of a coating system provided herein. A number of dry film thickness combinations of sealing agent, basecoat and topcoat were tested to determine appearance and durability of the coated fiber cement article. Table Two below outlines the preferred range of DFT values of the components of the coating system, defined as the mid target range. Also included are the minimum and maximum DFT values for each of the components of the coating system that will also achieve a stained look appearance whilst enhancing the wood grain pattern on the fibre cement composite article.

TABLE TWO
DFT values for the components of a coating system provided herein.

| DFT RANGE | SEALER | BASECOAT | TOPCOAT |
|---|---|---|---|
| MIN TARGET | 0.05 mils (1.27 μm), | 0.5 mils (12.7 μm) | 0.05 mils (1.27 μm) |
| MID TARGET | 0.3 and 1.0 mils | 1.3 and 2.5 mils | 0.3 and 1.0 mils |
| RANGE | (7.62 μm and 25.4 μm) | (33.02 μm and | (7.62 μm and 25.4 μm) |
| | | 63.5 μm) | |
| MAX TARGET | 1.5 mils (38.1 μm) | 3 mils (25.4 μm) | 1.5 mils (38.1 μm) |

The samples of coated fiber cement composite articles were tested using a standard QUVB accelerated weathering testing protocol to evaluate the degradation of coating systems provided herein over time.

### General Testing Information:

The QUVB test was performed under conditions that reproduced 4,000 hrs of exposure to normal weathering conditions such as sunlight, rain and dew. Coating system samples were exposed to 4 hours of UV rays at 60° C. with 0.81 MJ/m² irradiance and then a further 4 hours of exposure with condensation at 50° C. Measurements were conducted over a circular area 8 mm in diameter using an X-rite SP-64 model colorimeter. Each sample was measured at four locations and then the four measurements were averaged to give a value.

Coating System Samples were Formed as Follows:

3″×6″ samples of fibre cement composite material having a wood grain texture pattern in low relief of one surface were coated with one embodiment of a coating system provided herein. Initially the sealing agent was applied to the surface of each fibre cement composite substrate which had the wood grain texture pattern thereon. The sealing agent layer was then cured. In some samples a basecoat layer was applied to the sealing agent layer and cured. This layer was omitted from other samples. Finally a topcoat layer was applied to all samples and then cured. The DFT value and presence of UV absorbers/HALS for each sample layer is presented in TABLE THREE below.

TABLE THREE
Various samples having DFT values, tint, and UV absorbers/HALS in
components of a coating system provided herein.

| SAMPLE | | BASECOAT | |
|---|---|---|---|
| NUMBER | SEALER/DFT | DFT | TOPCOAT (DFT) |
| 1 | No Tint/0.5 mils | 1.75 mils | UVA/1 coat (=1.2 mils) |
| 2 | No Tint/0.5 mils | 1.75 mils | 1 coat (=1.2 mils) |
| 3 | No Tint/0.5 mils | 1.75 mils | UVA/2 coats (=2.4 mils |
| | | | total) |
| 4 | No Tint/0.5 mils | 1.75 mils | 2 coats (=2.4 mils total) |
| 5 | Tint + UVA/ | — | UVA/1 coat (=1.2 mils) |
| | 0.5 mils | | |
| 6 | Tint + UVA/ | — | 1 coat (=1.2 mils) |
| | 0.5 mils | | |
| 7 | Tint + UVA/ | — | UVA/2 coats (=2.4 mils |
| | 0.5 mils | | total) |
| 8 | Tint + UVA/ | — | 2 coats (=2.4 mils total) |
| | 0.5 mils | | |

### QUV Weathering Test 1:

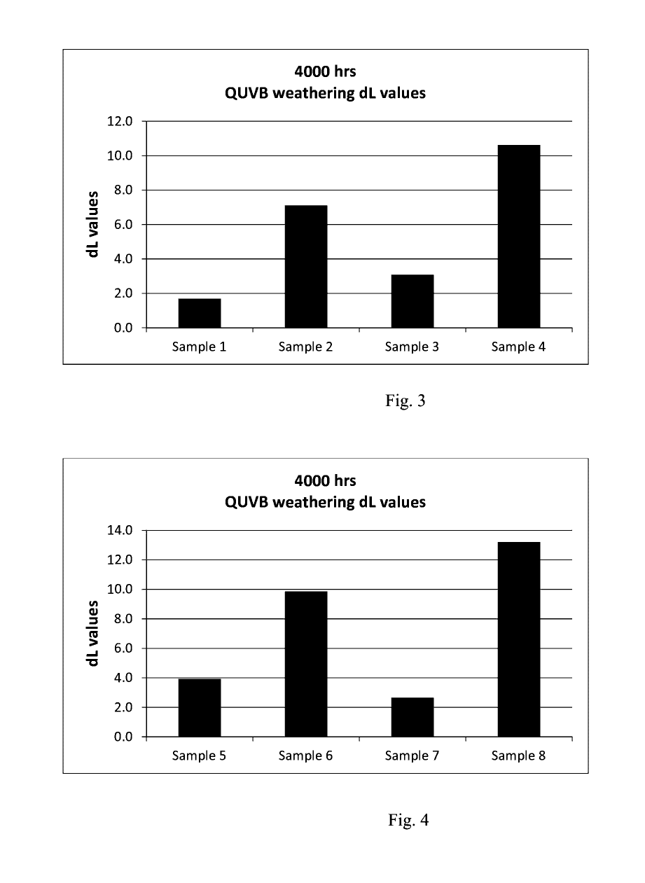

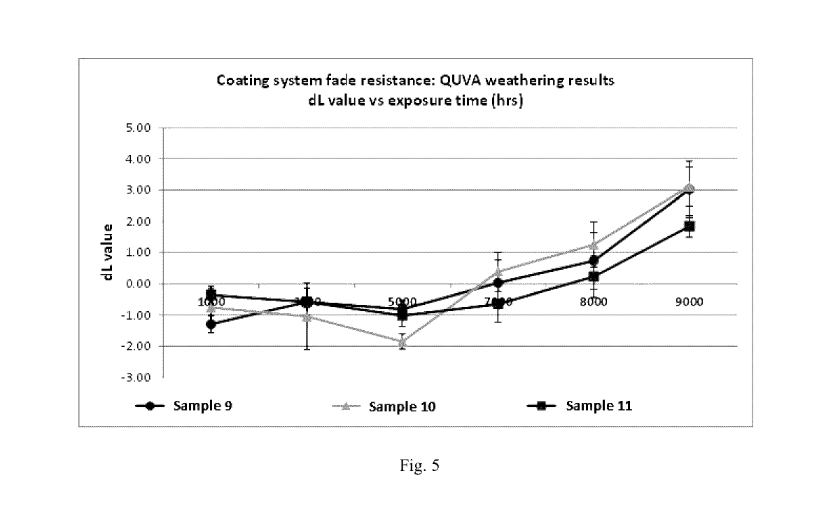

Each of the coated fiber cement composite material Samples 1 to 8 of TABLE THREE were measured to determine the lightness value (L), the red/green value (a), the yellow/blue value (b) and the total colour value (E). Each of the coated fiber cement composite material samples 1 to 8 were then placed in a QUV chamber for the UV exposure test as described above. After exposure, each of the the coated fiber cement composite material Samples 1 to 8 were again measured to determine the lightness value (L), the red/green value (a), the yellow/blue value (b) and the total colour value (E). Measurements of the difference in lightness (dL) (a positive dL number indicates lightening, a negative dL number indicates darkening), difference in the red/green value (da) (a positive number indicates more red, a negative number indicates more green), difference in the yellow/blue values (db) (a positive number indicates more yellow, a negative number indicates more blue) and the total colour difference (dE) between before exposure and after exposure are presented below in TABLE FOUR. The results shown in table four below and as illustrated in FIGS. 3 and 4 show that the fiber cement composite materials coated with the coating system of the present disclosure, and in particular the samples with the UV absorbers and HALS contained therein, had much better color stability than the other samples.

TABLE FOUR
QUV weathering test results for Samples 1-8.

| Sample | dL | Da | db | dE |
|---|---|---|---|---|
| 1 | 1.69 | −5.14 | −12.91 | 14.00 |
| 2 | 7.12 | −11.03 | −15.43 | 20.26 |
| 3 | 3.09 | −6.75 | −9.04 | 11.70 |
| 4 | 10.63 | −16.01 | −11.06 | 22.17 |
| 5 | 3.94 | −4.20 | −8.58 | 10.33 |
| 6 | 9.88 | −8.45 | −4.47 | 13.75 |
| 7 | 2.67 | −3.91 | −5.07 | 6.94 |
| 8 | 13.21 | −12.60 | −2.39 | 18.41 |

### QUV Weathering Test 2:

Fiber cement substrates coated with coating systems provided herein were exposed to QUVA, using a testing procedure as described above. Each sample was coated with sealer (0.5 mils DFT), basecoat (1.75 mils DFT), and topcoat (0.75 mils DFT). Sample 9 included an untinted sealing agent, Sample 10 included a tinted sealing agent and Sample 11 included a tinted sealing agent with UVA/HALS. The lower dL values of the Sample 11 system over time show the advantage of adding the UVA/HALS to the sealer. The Sample 11 system has less fade than Sample 9 or Sample 10. All three systems show color change, but the Sample 11 system had lower da and db changes over time. Overall, as seen in TABLE FIVE, Sample 11 retains its color better than Sample 9 or Sample 10, as indicated by generally smaller dL values. Thus, the coated fiber cement substrate maintains its wood-like appearance under weathering.

TABLE FIVE
QUV weathering test results for Samples 9-11.

| | Sample | | Sample | | Sample | |
|---|---|---|---|---|---|---|
| Exposure | 9 | Std. | 10 | Std. | 11 | Std. |
| (Hours) | dL | Dev. | dL | Dev. | dL | Dev. |
| 1000 | −1.29 | 0.27 | −0.75 | 0.59 | −0.36 | 0.27 |
| 3000 | −0.57 | 0.42 | −1.04 | 1.07 | −0.57 | 0.17 |
| 5000 | −0.81 | 0.28 | −1.85 | 0.24 | −1.01 | 0.36 |
| 7000 | 0.03 | 0.74 | 0.39 | 0.63 | −0.65 | 0.58 |
| 8000 | 0.74 | 0.91 | 1.26 | 0.73 | 0.23 | 0.66 |
| 9000 | 3.02 | 0.91 | 3.12 | 0.63 | 1.84 | 0.35 |

The foregoing description of the preferred embodiments of the present disclosure has shown, described and pointed out the fundamental novel features of coating systems provided herein. The various devices, methods, procedures, and techniques described above provide a number of ways to carry out the described embodiments and arrangements. Of course, it is to be understood that not necessarily all features, objectives or advantages described are required and/or achieved in accordance with any particular embodiment described herein. Also, although the invention has been disclosed in the context of certain embodiments, arrangements and examples, it will be understood by those skilled in the art that the invention extends beyond the specifically disclosed embodiments to other alternative embodiments, combinations, sub-combinations and/or uses and obvious modifications and equivalents thereof. Accordingly, the invention is not intended to be limited by the specific disclosures of the embodiments herein.

What is claimed is:

1. A coating system for a fiber cement composite article comprising a textured surface having a depth of relief, the coating system comprising:
a sealing agent selected for application to the textured surface of the fiber cement composite article, said sealing agent having a dry film thickness (DFT) of about 0.05 to 2 mils (1.27 μm to 50.8 μm);
a basecoat disposed on at least a portion of the sealing agent, said basecoat having a DFT of 0.5 to 5 mils (12.7 μm to 127 μm);
a topcoat disposed on at least a portion of the basecoat, said topcoat having a DFT of 0.05 to 2 mils (1.27 μm to 50.8 μm);
wherein the difference between the lightness value (DL) between the topcoat and the basecoat is negative;
wherein the textured surface has a depth of relief of about 5 to 50 mils (127 μm to 1.3 mm); and
wherein the ratio of the of sealing agent DFT to depth of relief is about 0.5:1 to about 5:1.

2. The coating system of claim 1, wherein the sealing agent comprises at least one resin selected for film formation.

3. The coating system of claim 1, wherein the sealing agent comprises an epoxy silane resin.

4. The coating system of claim 1, wherein the difference in lightness value (DL) between the topcoat and the basecoat is approximately −25 to −35.

5. The coating system of claim 1, wherein the difference in the red/green value (Da) between the topcoat and the basecoat is approximately 0.01 to 1.

6. The coating system of claim 1, wherein the difference in the yellow/blue value (Db) between the topcoat and the basecoat is approximately −1 to −6.

7. The coating system of claim 1, wherein the difference in the total colour value (DE) between the topcoat and the basecoat is approximately 25 to 35.

8. The coating system of claim 1, wherein the sealing agent comprises less than about 10% pigment by weight.

9. The coating system of claim 1, wherein the Pigment Volume Concentration (PVC) of the sealing agent is less than about 10%.

10. The coating system of claim 1, wherein each of the sealing agent, the basecoat and the topcoat further comprises at least one of a UV absorber or a Hindered Amine Light Stabiliser (HALS).

11. The coating system of claim 10, wherein the UV absorber comprises a UV absorber based on 2-hydroxyphenyl-benzophenone, 2-(2-hydroxyphenyl)benzotriazole or 2-hydroxyphenyl-s-triazine.

12. The coating system of claim 10, wherein the HALS comprises a di- or oligo-functional HALS based on a tetramethylpiperidine derivative.

13. A coated fiber cement composite article having the appearance of wood, comprising:
a fiber cement composite article comprising a textured surface having a depth of relief, and a coating system disposed on the textured surface;
wherein the coating system comprises a sealing agent layer, a basecoat layer and a topcoat layer;
wherein the sealing agent layer is disposed on at least a portion of the textured surface of the fiber cement composite article such that the Dry Film Thickness (DFT) of the sealing agent layer is about 0.05 to 2 mils (1.27 μm to 50.8 μm);
wherein the basecoat is disposed on at least a portion of the sealing agent layer such that the DFT of the basecoat is about 0.5 to 5 mils (12.7 μm to 127 μm); and
wherein the topcoat is disposed on at least a portion of the basecoat layer such that the DFT of the topcoat is about 0.05 to 2 mils (1.27 μm to 50.8 μm); and
wherein the depth of relief is about 5 to 50 mils (127 μm to 1.3 mm).

14. The coated fiber cement composite article of claim 13, wherein the sealing agent layer is characterized by a DFT from about 0.1 to 1.5 mils (2.54 μm to 38.1 μm).

15. The coated fiber cement composite article of claim 13, wherein the basecoat is characterized by a DFT from about 1 to 3 mils (25.4 μm to 76.2 μm).

16. The coated fiber cement composite article of claim 13, wherein the topcoat is characterized by a DFT from about 0.1 to 1.5 mils (2.54 μm to 38.1 μm).

17. A siding panel, plank, shingle, trim or decking comprising the coated fiber cement composite article of claim 13.

18. The coated fiber cement composite article of claim 13, wherein the ratio of sealer layer DFT:basecoat layer DFT:topcoat layer DFT is about 1:10:1 to 1:2:2.

19. The coated fiber cement composite article of claim 13, wherein the textured surface has a depth of relief of about 15 to 35 mils (381 μm to 889 μm).

20. The coated fiber cement composite article of claim 13, characterized by having a change in dL after 9000 hours of exposure to UV of less than about 10.

21. A method of manufacturing a coated fibre cement composite article having the appearance of wood, the method comprising the steps of:
(a) providing a fibre cement composite substrate with a wood grain texture having a depth of relief on at least one surface;
(b) applying at least one coat of a sealing agent comprising at least one of a UV absorber or a Hindered Amine Light Stabiliser (HALS) to at least a portion of the surface having a wood grain texture;
(c) at least partially curing the sealing agent to form a sealing agent layer having a dry film thickness (DFT) of about 0.05 to 2 mils (1.27 μm to 50.8 μm); then
(d) applying at least one coat of a basecoat comprising at least one of a UV absorber or a HALS to at least a portion of the at least partially cured sealing agent layer;
(e) at least partially curing the basecoat to form a basecoat layer having a DFT of 0.5 to 5 mils (12.7 μm to 127 μm); then
(f) applying at least one coat of a topcoat comprising at least one of a UV absorber or a HALS to at least a portion of the at least partially cured basecoat layer; and
(g) at least partially curing the topcoat to form a topcoat layer having a DFT of about 0.05 to 2 mils (1.27 μm to 50.8 μm);
wherein the ratio of the of sealing agent layer DFT to depth of relief is about 0.5:1 to 5:1.
